(19) United States
(12) Patent Application Publication
(10) Pub. No.: US 2016/0232120 A1
(43) Pub. Date: Aug. 11, 2016

(54) READING APPARATUS

(71) Applicant: Chant Sincere Co., Ltd., New Taipei City (TW)

(72) Inventors: Yong-Sheng LIN, New Taipei City (TW); Yu-Chien CHUEH, New Taipei City (TW); Chen-An WU, New Taipei City (TW); Chien Chun WU, New Taipei City (TW); Cheng-Hui FAN, New Taipei City (TW)

(21) Appl. No.: 14/958,965

(22) Filed: Dec. 4, 2015

(30) Foreign Application Priority Data
Feb. 6, 2015 (TW) 104201949

(51) Int. Cl. G06F 13/38; G06F 13/20; G06F 13/40; G06F 13/10

(52) U.S. Cl. CPC G06F 13/385; G06F 13/102; G06F 13/20; G06F 13/4068

(57) ABSTRACT

A reading apparatus suited for being inserted into a first electronic device or a second electronic device is disclosed. The first electronic device has a first interface receptacle. The second electronic device has a second interface receptacle. The reading apparatus has a first interface-module and a second interface-module. The first interface-module comprises a plurality of pins corresponding to the first interface receptacle and used to transmit a first interface signal. The pins comprise a plurality of first pins which are disposed on a top surface of a circuit board, and comprises a first positive-negative direction determining pin which is used to confirm whether the first interface-module is positively inserted or negatively inserted into and the first interface receptacle. The second interface-module comprises a plurality of conduction pad corresponding to the second interface receptacle and used to transmit a second interface signal.

### CROSS-REFERENCE TO RELATED APPLICATIONS

This application claims the benefit of the filing date under 35 U.S.C. §119(a)-(d) of Taiwan Patent Application No. 104201949, filed Feb. 6, 2015.

### BACKGROUND OF THE INVENTION

1. Field of the Invention

The present invention relates to a reading apparatus, and in particular to a reading apparatus with different transmitting interfaces.

2. Description of the Related Art

Conventional reading apparatuses, are able to store different kinds of memory cards such as compact flash (CF) cards, multimedia cards (MMC), secure digital (SD) cards, Micro SD cards, memory stick micro (M2) cards, etc. By means of the reading apparatus, transferring a data signal stored in these memory cards to another electronic product, or alternatively, expanding the memory for an electronic product can be achieved.

However, there are many kinds of electronic products in which a variety of specifications for a transferring interface are provided. When there is a need for exchanging data between different electronic products, it will require different reading apparatuses with different transferring interfaces. The conventional reading apparatus always has only been equipped with one kind of transferring interface and thus costs extra money, space, and mind for preparing different reading apparatuses with different transferring interface specifications with respect to different every electronic products. Moreover, a manufacturer of a reading apparatus is required to manufacture a reading apparatus product which complies with the devices with the corresponding transferring interface specifications, and thus increases the price.

### SUMMARY OF THE INVENTION

Accordingly, the purpose of the present invention is to provide a reading apparatus that has different transferring interfaces.

Thus, the reading apparatus of the present invention is provided for plugging into a first electronic device which has a first interface connector, or for plugging into a second electronic device which has a second interface connector.

The reading apparatus of the present invention comprises a circuit board, a first interface-module, a second interface-module, a storing module, and a processor.

The first interface-module is provided on the circuit board, the first interface-module includes a housing and a plurality of pins provided in the housing, wherein the pins are electrically connected to the circuit board in correspondence with the first interface connector for transferring first interface signals. The pins comprise a plurality of first pins which are disposed on a top surface of the circuit board, and the plurality of first pins comprise a first positive-negative direction determining pin which is used to confirm whether the first interface-module is positively inserted or negatively inserted into the first interface receptacle.

The second interface-module is provided on a side of the circuit board opposite the first interface-module, the second interface-module including a plurality of conduction pads directly configured on one surface of the circuit board in correspondence with the second interface connector for transferring second interface signals.

The storing module is electrically connected with the circuit board for storing data. The storing module comprises a plurality of resilient pins fixed on the insulating frame and a memory card, wherein a preserved space for the memory card, is defined by the insulating frame and the resilient pins; and the resilient pins have a plurality of soldering portions respectively electrically connected to the circuit board, and a plurality of resilient arms, respectively provided at an opposite end of the soldering portions and electrically connected to the memory card.

The processor is electrically connected with the circuit board for converting signals read from the storing data to the first interface signals or the second interface signals; and converting the first interface signals or the second interface signals to signals writing into the storing data.

Preferably, the first interface-module is further provided with a first shell provided in at one side of the housing opposite to the circuit board, the pins are provided in the first shell, and the first shell has a mating slot for mating the first interface connector.

Preferably, the second interface-module further includes a second shell defining a receiving space, in which the conduction pads are disposed, and the receiving space has an opening.

Preferably, the first interface-module is further provided with a first shell at one side of the housing opposite the circuit board, the pins are provided in the first shell, the first housing has a mating slot provided for mating the first interface connector; the reading apparatus further comprises a body case which includes a surrounding wall and an end wall connected with the surrounding wall, wherein an inner space is defined by the surrounding wall and an end wall, and the inner space is fitted around the housing seat, a part of the circuit board, and a part of the second shell, and the end wall has a aperture provided for having the first shell therein.

Preferably, the storing module of the present invention is an System-in-Package (SIP) circuit unit.

Preferably, the storing module of the present invention includes a memory unit mounted on the circuit board.

Preferably, the reading apparatus of the present invention is adaptable to the first interface receptacle of the first electronic device and the second interface receptacle of the second electronic device. The processor of the reading device is configured to convert the first interface signal into the second interface signal and convert the second interface signal into the first interface signal.

Preferably, the first interface-module is designed to comply with USB C-type specifications, and the second interface-module is designed to comply with USB specifications.

Preferably, the pins comprise a plurality of second pins which are disposed on a bottom surface of the circuit board, and the plurality of second pins comprise a second positive-negative direction determining pin which is used to confirm whether the first interface-module is positively inserted or negatively inserted into the first interface receptacle.

The present invention has the following merits. By means of using the first interface-module to transfer first interface signals, using the second interface-module to transmit second interface signals, and utilizing the storing module for data storage, a processor can be for converting stored signals generated by the storing module to first interface signals or second interface signals, converting the first interface signals or the second interface signals to the stored signals, converting the first interface signals to the second interface signals, and converting the second interface signals to the first interface signals, so that the capability of data transmission between different interfaces can be achieved.

### BRIEF DESCRIPTION OF THE DRAWINGS

FIG. 1 is a perspective view of a reading apparatus that is plugged into a first electronic device, according to a first preferred embodiment of the present invention;

FIG. 2 is a perspective view of a reading apparatus that is plugged into a second electronic device, according to the preferred embodiment of FIG. 1;

FIG. 3 is an exploded perspective view of the preferred embodiment of FIG. 1;

FIG. 4 is an exploded perspective view viewed from another direction corresponding to FIG. 3;

FIG. 5 is a perspective view corresponding to FIG. 4;

FIG. 6 is a rear view corresponding to FIG. 5;

FIG. 7 is a top view corresponding to FIG. 5;

FIG. 8 is a cross-sectional view taken along line XIII-VIII of FIG. 7;

FIG. 9 is a perspective view of a body case according to a second preferred embodiment of the present invention;

FIG. 10 is a schematic perspective view of a storing module as an SIP circuit unit;

FIG. 11 is a rear view of the preferred embodiment of FIG. 9;

FIG. 12 is a perspective view of a memory unit of the reading apparatus that is directly mounted on a circuit board according to a third preferred embodiment of the present invention; and

FIG. 13 is a rear view of the preferred embodiment of FIG. 12.

### DETAILED DESCRIPTION OF THE EMBODIMENT(S)

To clarify the above objects and effect of the present invention, a more detailed description will be described by referring to the following embodiments and the drawings of the present invention. Similar elements will be referred to by using the same reference numeral.

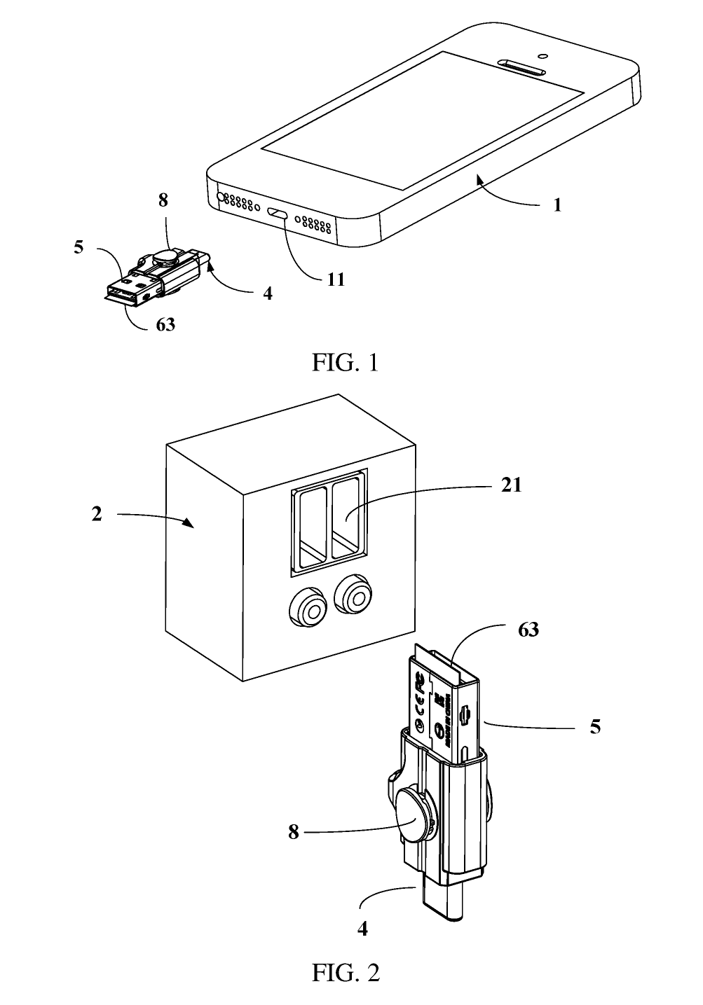

As referring to FIGS. 1-3, a reading apparatus of a first preferred embodiment of the present invention is provided to plug to a first electronic device 1 which has a first interface connector 11 and/or plug to a second electronic device 2 which has a second interface connector 21. In this embodiment, the first electronic device 1 is a handheld device, such as a smart phone. The first interface connector 11 is designed to comply, or is in compliance with, with the universal serial bus (USB) C-type specification, for example, a micro USB receptacle. The second electronic device 2 is a computer device (host), and the second interface connector 21 is designed to comply, or is in compliance with, with the USB specification. However, the present invention is not limited to this embodiment. Alternatively, the first electronic device 1 can be a device with receptacle(s) of USB C-type specification, and the second electronic device 2 can be a device with receptacle(s) of USB specification. In this embodiment, the reading apparatus includes a circuit board 3, a first interface-module 4, a second interface-module 5, a storing module 6, a processor 7, and a body case 8.

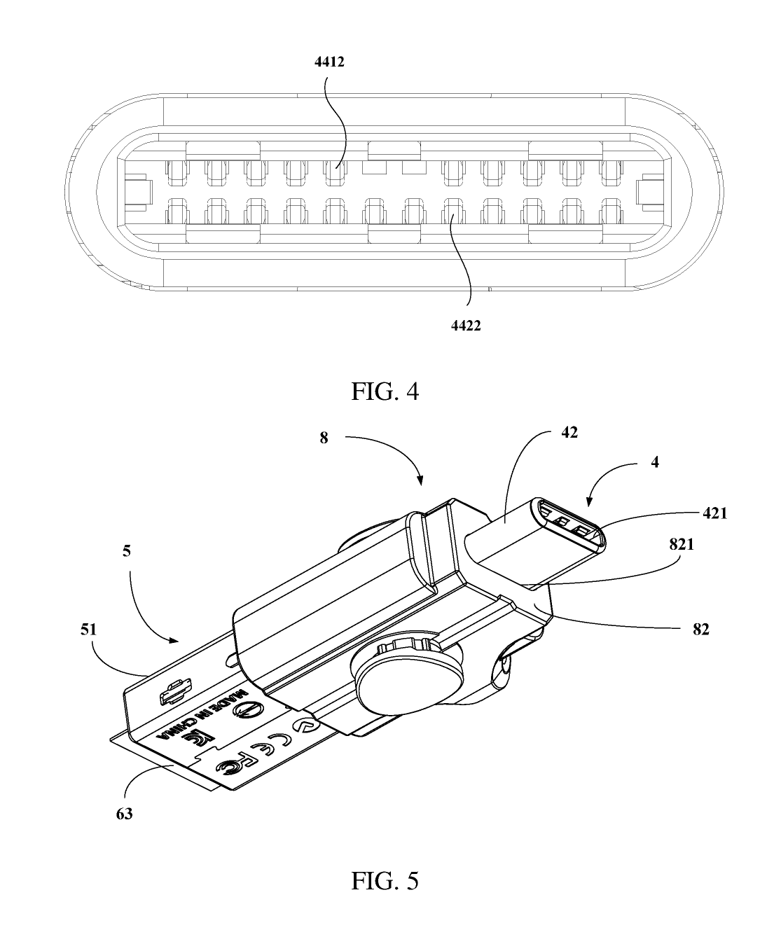

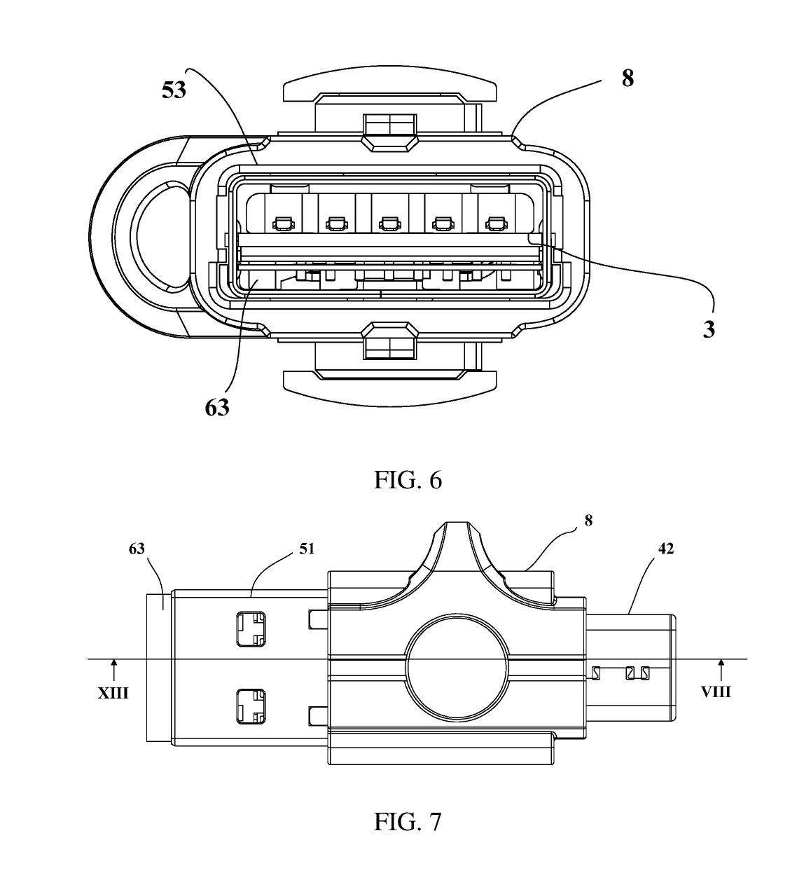

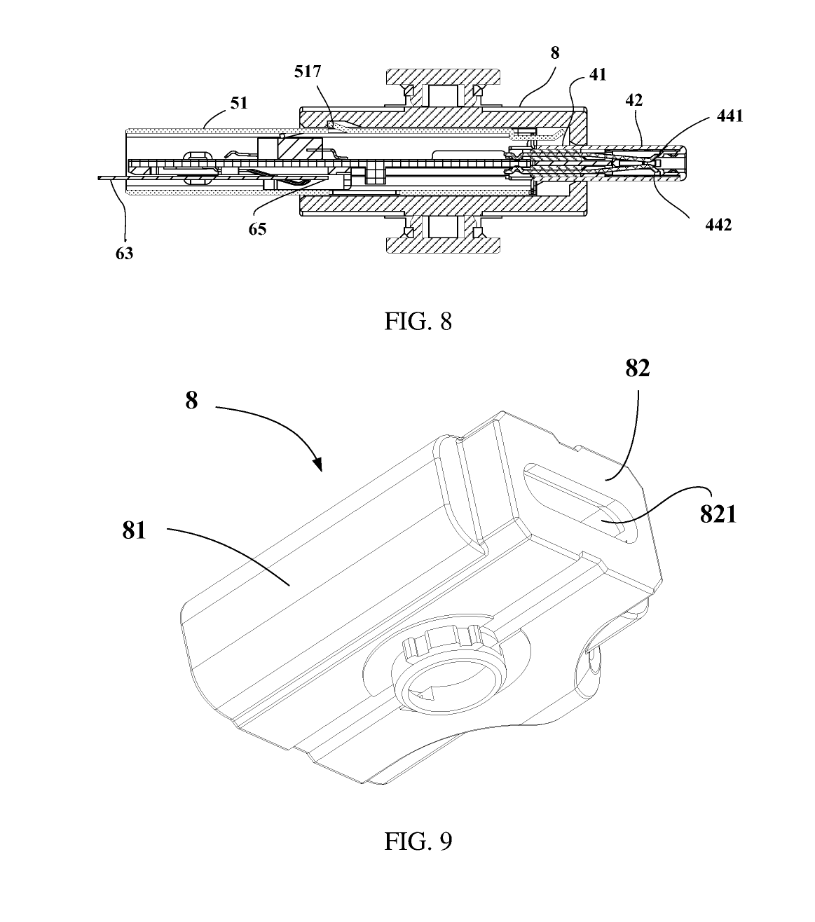

As referring to FIGS. 3-6, the circuit board 3 includes: a plurality of connecting pads 31 which are directly formed on the surface of the circuit board 3, two retaining holes 32 that are spaced apart, two first holes 33 which are spaced apart and are provided opposite to the retaining holes 32, two second holes 34 provided between the retaining holes 32 and the first holes 33, and a plurality of soldering pads 35.

The first interface-module 4 is provided on the circuit board 3 and includes: a housing 41, a first shell 42 provided at a side of the housing 41 opposite to the circuit board 3, two protrudes 43 respectively extended from the housing 41 toward the circuit board 3 and respectively connected to the retaining holes 32, and a plurality of pins 44 provided in the first shell 42. The pins 44 are electrically connected with the connecting pads 31 of the circuit board 3. The first shell 42 has a mating slot 421 for mating the first interface connector 11. The pins 44, the first shell 42, and the first interface connector 11 (as shown in FIG. 1) are corresponding with each other and are all in compliance with the USB C-type specification for transferring first interface signals (i.e., signals for performing USB C-type function). The pins 44 comprise a plurality of first pins 441 which are disposed on a top surface of the circuit board 3, and the plurality of first pins 441 comprise a first positive-negative direction determining pin 4412 which is used to confirm whether the first interface-module 4 is positively inserted or negatively inserted into and the first interface receptacle 11. Concerning cost, a portion of products might only dispose the plurality of first pin 441. Additionally, in the present embodiment, the plurality of pins 44 further comprise a plurality of second pins 442 which are disposed on a bottom surface of the circuit board 3. The plurality of second pins 442 comprise a second positive-negative direction determining pin 4422 which is used to confirm whether the first interface-module 4 is positively inserted or negatively inserted into and the first interface receptacle 11. Generally, the second positive-negative direction determining pin 4422 is CC2 (configuration channel), which is a pin for determining positive-insertion or negative-insertion in USB C-type specification.

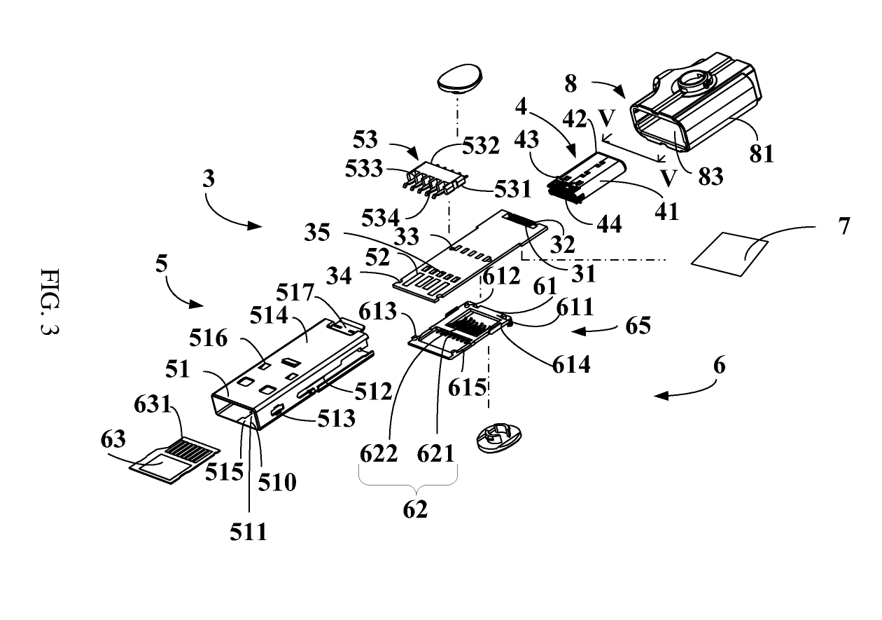

The second interface-module 5 is disposed on a side of the circuit board 3 opposite to the first interface-module 4. The second interface-module 5 includes a second shell 51 for defining a receiving space 511, a plurality of conduction pads 52 that are contained in the receiving space 511, and a stopping member 53. The conduction pads 52 are directly formed on the surface of the circuit board 3 relative to the second interface connector 21 (as shown in FIG. 2). Both the conduction pads 52 and the second interface connector 21 are in compliance with the USB specification for transferring second interface signals (i.e. USB signals.) The receiving space 511 has an opening 510 in communication with the outside of the receiving space 511.

Specifically, the second shell 51 has two first cutouts 512 that are located at two opposite sides of the second shell 51, two second cutouts 513 that are located at two opposite sides of the second shell 51, a jointing plate 514, a sealing plate 515 which is opposite the jointing plate 514, two first protrusions 516 that are respectively extending from the jointing plate 514 toward the sealing plate 515, and a second protrusion 517 which is extending away from the jointing plate 514 toward the sealing plate 515. The stopping member 53 has two side walls 531, a rear wall 532 that connects the two side walls 531, two notches 533 respectively formed on the rear wall 532 for fastening the two first protrusions 516 respectively, and an edge 534 extending from the rear wall 532 toward the circuit board 3. The side walls 531 and the edge 534 are provided on the circuit board 3 for enabling the pin of the second interface connector 21 (not shown) to push against the edge 534 for preventing the pins of the second interface 21 from plugging in too deep.

The storing module 6 is electrically connected to the circuit board 3 for storing data. The storing module 6 includes an insulating frame 61 provided on a side of the circuit board 3 opposite the conduction pads 52, a plurality of resilient pins 62 that are fixed on the insulating frame 61, a memory card 63, and a card ejecting member 64. A preserved space 65 is defined by the insulating frame 61 and the resilient pins 62 for receiving the memory card 63. The memory card 63 has a plurality of pads 631. In this embodiment, the memory card 63 is not limited to an SD card, but other types of memory cards also can be used. The resilient pins 62 have a plurality of soldering portions 621 respectively electrically connected to the soldering pads 35 of the circuit board 3, and a plurality of resilient arms 622 which are respectively provided opposite to the soldering portions 621 and are electrically connected to the pads 631 of the memory card 63.

Specifically, the insulating frame 61 includes: a body 611, two first rods 612 that are respectively extending from the body 611 toward the circuit board 3 for jointing to the second holes 34 of the circuit board 3, two second rods 613 that are respectively extending from the body 611 toward the circuit board 3 for jointing to the first holes 33 of the circuit board 3, two first protrudes 614 that are respectively bulged from the two opposite sides of the body 611 for jointing to the first cutouts 512 of the second shell 51, and two second rods 615 that are respectively extending from the two opposite sides of the body 611 for jointing to the second cutouts 513 of the second shell 51.

The processor 7 is provided on the circuit board 3 for converting signals read from the storing data to the first interface signals or the second interface signals, and for converting the first interface signals or the second interface signals to signals writing into the storing data.

The body case 8 includes a surrounding wall 81 and an end wall 82 that is connected to one side of the surrounding wall 81. The surrounding wall 81 and the end wall 82 define an inner space 83. The inner space 83 is fitted around by the housing 41, a part of the circuit board 3, and a part of the second shell 51. The end wall 82 comprises a through slot 821 for the first shell 42.

The method of using the reading apparatus in this embodiment is described as follows.

As referring to FIGS. 1, 3, the memory card 63 can be plugged into the preserved space 65, and then the mating slot 421 of the first interface-module 4 of the reading apparatus can be connected to the first interface connector 11 of the first electronic device 1. By operating a software (not shown) of the first electronic device 1, storing signals generated by the stored data on the memory card 63 can be converted to the first interface signals by the processor 7 and can be transferred to a storing unit (not shown) of the first electronic device 1, and the first interface signals generated by the stored data on the first electronic device 1 can be transferred to the processor 7 to be converted to the stored signals, so that the data on the first electronic device 1 can be backup to the memory card 63.

As referring to FIGS. 2-3, the opening 510 of the second interface-module 5 of the reading apparatus can be plugged into the second interface connector 21 of the second electronic device 2. By operating a software (not shown) of the second electronic device 2, storing signals generated by the stored data on the memory card 63 can be converted to the second interface signals by the processor 7 and can be transferred to a storing unit (not shown) of the second electronic device 2, and the second interface signals generated by the second electronic device 2 can be transferred to the processor 7 to be converted to the stored signals, so that the data on the second electronic device 2 can be backup to the memory card 63.

Alternatively, the reading apparatus of the present invention can be simultaneously connected to the first electronic device 1 and the second electronic device 2. Specifically, the mating slot 421 of the first interface-module 4 can be plugged into the first interface connector 11 of the first electronic device 1, and the opening 510 of the second interface-module 5 can be plugging into the second interface connector 21. In other words, by operating a software (not illustrated in the drawings) of the second electronic device 2, second interface signals generated by the data transmission can be transferred to the processor 7 to be converted to the first interface signals and be stored onto the storing unit of the first electronic device 1. Preferably, by operating a software (not illustrated in the drawings) of the second electronic device 2, a second interface signal generated by the data transmission can be transferred to the processor 7 to be converted to the storing signal, so that the data on the second electronic device 2 can be backup to the memory card 63. In other words, the data on the second electronic device 2 can be transferred to both the first electronic device 1 and the reading apparatus.

Or, the first interface signals generated by the stored data on the first electronic device 1 can be transferred to the processor 7 to be converted to the second interface signals, and be stored on the storing unit of the second electronic device 2. Preferably, by operating a software (not shown) of the first electronic device 1, the first interface signals generated by the data transmission can be transferred to the processor 7 to be converted to the stored signal, so that the data on the first electronic device 1 can be backup to the memory card 63.

In another embodiment, when the memory card 63 is not plugged into the plugging space 65 and the reading apparatus is simultaneously connected to both the first electronic device 1 and the second electric device 2, the reading apparatus of the present invention only serves as a transferring medium between the first electronic device 1 and the second electronic device 2.

Therefore, by using the reading apparatus of the present invention, the data transmission between the first electronic device 1 and the second electronic device 2 can be easier and has a more versatile way of transferring data. Additionally, the reading device of the present invention provides more convenience to reading device users in a way that the device does not take extra storage spaces. For the reading apparatus manufacturers, the reading apparatus of the present invention is capable of lowering their production cost in a way that they only need to manufacture the reader apparatus of the present invention, the data transmission between the first electronic device 1 and the electronic device 2 can be achieved.

In FIGS. 9-11, the reading apparatus according to the second preferred embodiment of the present invention is illustrated, which is generally similar to that of the first preferred embodiment. The difference between the two reading apparatus is that the aspect of the storing module 6 in the second preferred embodiment is different from the tangible memory card 63 which is plugged into the opening 510, as shown in the first preferred embodiment in FIG. 3. In other words, the storing module 6 in the second preferred embodiment is not provided with the insulating frame 61, the resilient pins 62 and the preserved space 65; and the surrounding wall 81 of the body case 8 is a closed surrounding wall 81.

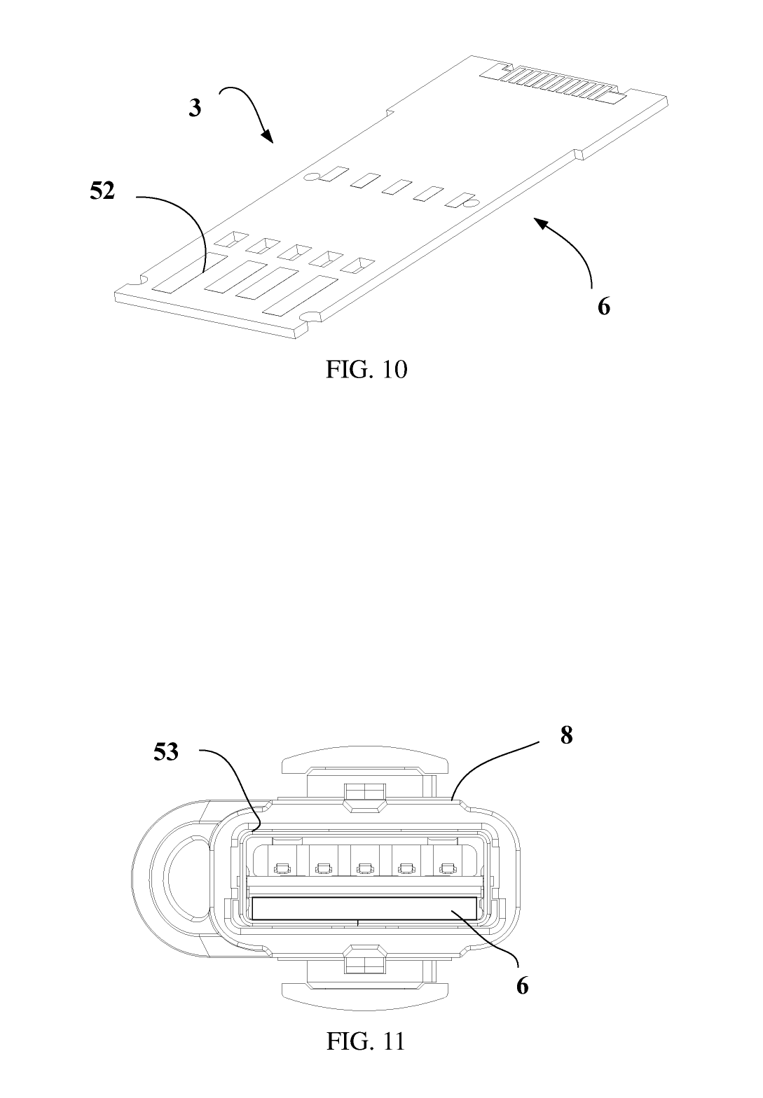

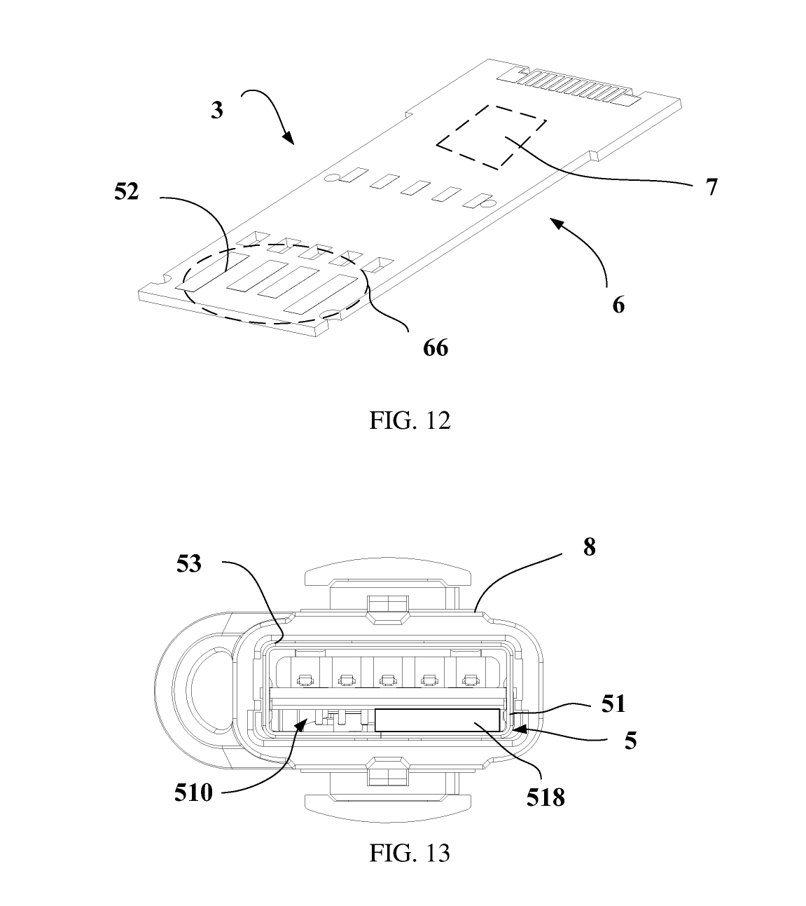

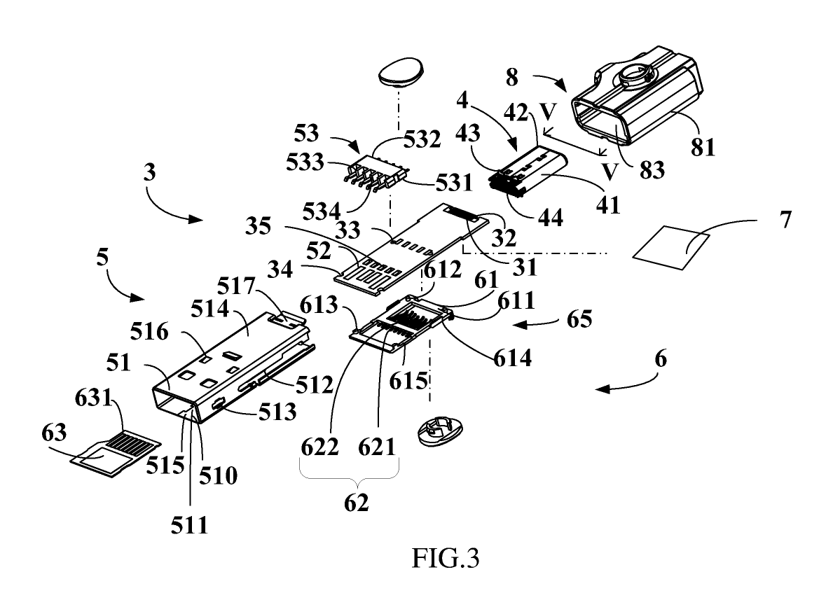

As referring to FIGS. 10, 12, the storing module 6 is a SIP (System in Package) circuit unit. In other words, the circuit board 3, the processor 7, the conducting pads 52 and a storage chip are integrated within the circuit unit and are integrally packaged with above elements as a chip. Referring to FIGS. 11, 13, the third preferred embodiment of the present invention is generally similar to the second preferred embodiment. The difference between the two embodiments is the aspect of the storing module 6.

As referring to FIG. 12, the storing module 6 in the third preferred embodiment includes a memory unit 66. The memory unit 66 is a memory chip directly mounted on the circuit board 3 (Chip on Board, COB), and the wire bonding between the memory chip and the circuit board 3 is protected by a sealant.

Preferably, as referring to FIGS. 12, 13, in the second interface-module 5, the second shell 51 of the second interface-module 5 has a blocking wall 518 which blocks a part of the opening 510 for preventing dirt and oxidization which may affect the function of the memory unit 66 and the circuit board 3.

According to the above description of the reading apparatus of the present invention, upon the first interface-module 4 transfers first interface signals, the second interface-module 5 transfers second interface signals, and the storing module 6 transfers storing data, the processor 7 can convert a stored signal generated by the storing module 6 to the first interface signals or the second interface signals; the first interface signals or the second interface signals into the stored signals; the first interface signals into the second interface signals; and the second interface signals into the second interface signals, so that the purpose of transferring data among various interfaces can be achieved.

While the invention has been described in terms of various specific embodiments, those skilled in the art will recognize that the invention can be practiced with modification within the spirit and scope of the claims.

What is claimed is:

1. A reading apparatus adaptable to a first electronic device and a second electronic device, the first electronic device having a first interface connector and the second electronic device having a second interface connector, the reading apparatus comprising:
a circuit board;
a first interface-module, provided on the circuit board, comprising a housing and a plurality of pins provided in the housing, wherein the pins, electrically connected to the circuit board in correspondence with the first interface connector for transferring first interface signals, comprise a plurality of first pins disposed on a top surface of the circuit board, and the plurality of first pins comprise a first positive-negative direction determining pin which is used to confirm whether the first interface-module is positively inserted or negatively inserted into and the first interface receptacle;
a second interface-module, which is provided on a side of the circuit board opposite to the first interface-module, comprising a plurality of conduction pads directly configured on one surface of the circuit board in correspondence with the second interface connector for transferring second interface signals; a storing module electrically connected with the circuit board for storing data;
wherein said storing module, comprising an insulating frame provided on one side of the circuit board opposite to the conduction pads, and comprising a plurality of resilient pins fixed on the insulating frame and a memory card, wherein a preserved space for the memory card, is defined by the insulating frame and the resilient pins; and the resilient pins have a plurality of soldering portions respectively electrically connected to the circuit board, and a plurality of resilient arms, respectively provided at an opposite end of the soldering portions and electrically connected to the memory card; and
a processor, electrically connected with the circuit board, for converting signals read from the storing data to the first interface signals or the second interface signals, and for converting the first interface signals or the second interface signals to signals writing into the storing data.

2. The reading apparatus of claim 1, wherein the first interface-module is further provided with a first shell at one side of the housing opposite to the circuit board, the pins are configured in the first shell, and the first shell has a mating slot for mating the first interface connector.

3. The reading apparatus of claim 1, wherein the second interface-module further comprises a second shell defining a receiving space, in which the conduction pads are disposed, and the receiving space configures an opening.

4. The reading apparatus of claim 3 further comprising a body case with a surrounding wall and an end wall connected with the surrounding wall, wherein the first interface-module is further provided with a first shell at one side of the housing opposite to the circuit board, and the pins are configured in the first shell with a mating slot provided for mating the first interface connector; an inner space defined by the surrounding wall and the end wall, is fitted around the housing, a part of the circuit board, and a part of the second shell, and the end wall has a aperture provided for inserting the first shell therein.

5. The reading apparatus of claim 1, wherein the storing module is a System-in-Package (SIP) circuit unit.

6. The reading apparatus of claim 1, wherein the storing module comprises a memory unit mounted on the circuit board.

7. The reading apparatus of claim 1, adaptable to the first interface connector of the first electronic device and the second interface connector of the second electronic device, wherein the processor is configured to convert the first interface signals to the second interface signals and convert the second interface signals to the first interface signals.

8. The reading apparatus of claim 1, wherein the first interface-module is designed to comply with USB C-type specification and the second interface-module is designed to comply with USB specification.

9. The reading apparatus of claim 1, wherein the pins comprises a plurality of second pin which are disposed on a bottom surface of the circuit board, and the plurality of second pins comprises a second positive-negative direction determining pin which is used to confirm whether the first interface-module is positively inserted or negatively inserted into and the first interface receptacle.
